(19) United States
(12) Patent Application Publication
(10) Pub. No.: US 2012/0144837 A1
(43) Pub. Date: Jun. 14, 2012

(54) Low Emission Power Generation and Hydrocarbon Recovery Systems and Methods

(76) Inventors: Chad Rasmussen, Houston, TX (US); Richard A. Huntington, Houston, TX (US); Dennis O'Dea, Somerset, NJ (US); Franklin F. Mittricker, Jamul, CA (US); Frank Hershkowitz, Basking Ridge, NJ (US)

(21) Appl. No.: 13/387,617

(22) PCT Filed: Jul. 9, 2010
(86) PCT No.: PCT/US10/41548

§ 371 Date: Jan. 27, 2012

Related U.S. Application Data
(60) Provisional application No. 61/238,971, filed on Sep. 1, 2009.

(51) Int. Cl. F02C 1/00

(52) U.S. Cl. 60/772; 60/39.19

(57) ABSTRACT

Methods and systems for oxyfuel based low emission power generation in hydrocarbon recovery processes are provided. One system includes a plenum and is configured to encourage post-combustor conversion of gaseous components such that a desired chemical state is achieved. Another system includes a steam reformer for reforming a control fuel stream to generate a reformed control fuel stream characterized by an increase in hydrogen, as compared to the control fuel stream.

### CROSS-REFERENCE TO RELATED APPLICATION

This application claims the benefit of U.S. Provisional Patent Application 61/238,971 filed 1 Sep. 2009 entitled LOW EMISSION POWER GENERATION

AND HYDROCARBON RECOVERY SYSTEMS AND METHODS, the entirety of which is incorporated by reference herein.

### FIELD OF THE INVENTION

Embodiments of the invention relate to low emission power generation in hydrocarbon recovery processes. More particularly, embodiments of the invention relate to methods and systems for using high turbine discharge temperatures generated by oxyfuel combustion (i) to encourage post-combustor conversion of gaseous components such that a desired chemical state is achieved and (ii) to reform a control fuel stream to generate a reformed control fuel stream characterized by an increase in hydrogen.

### BACKGROUND OF THE INVENTION

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Many enhanced hydrocarbon recovery operations can be classified as one of the following types: pressure maintenance and miscible flooding. In a pressure maintenance operation, inert gasses such as nitrogen are injected into a primarily gaseous reservoir to maintain at least a minimal pressure in the reservoir to prevent retrograde condensation and improve total recovery. In a miscible flooding operation, miscible gasses such as carbon dioxide are injected into a primarily liquidous reservoir to mix with the liquids, lowering their viscosity and increasing pressure to improve the recovery rate.

Many oil producing countries are experiencing strong domestic growth in power demand and have an interest in enhanced oil recovery (EOR) to improve oil recovery from their reservoirs. Two common EOR techniques include nitrogen (N₂) injection for reservoir pressure maintenance and carbon dioxide (CO2) injection for miscible flooding for EOR. At the same time there is a global concern regarding green house gas (GHG) emissions. This concern combined with the implementation of cap-and-trade policies in many countries make reducing CO2 emissions a priority for these and other countries as well as the companies that operate hydrocarbon production systems therein.

Some approaches to lower CO2 emissions include fuel de-carbonization or post-combustion capture. However, both of these solutions are expensive and reduce power generation efficiency, resulting in lower power production, increased fuel demand and increased cost of electricity to meet domestic power demand. Another approach is an oxyfuel gas turbine in a combined cycle (e.g. where exhaust heat from the gas turbine Brayton cycle is captured to make steam and produce additional power in a Rankin cycle). However, the power required to produce high purity oxygen significantly reduces the overall efficiency of the process. Several studies have compared these processes and show some of the advantages of each approach. See, e.g. BOLLAND, OLAV, and UNDRUM, HENRIETTE, Removal of CO₂ from Gas Turbine Power Plants: Evaluation of pre-and post-combustion methods, SINTEF Group, found at http://www.energy.sintef.no/publ/xergi/98/3/3art-8-engelsk.htm (1998).

Nonetheless, there is still a substantial need for a low emission, high efficiency power generation and hydrocarbon recovery process.

### SUMMARY OF THE INVENTION

A low emission, high efficiency power generation and hydrocarbon recovery process is described in PCT Patent Application PCT/US2009/038247 titled “LOW EMISSION POWER GENERATION AND HYDROCARBON RECOVERY SYSTEMS AND METHODS” which claims the benefit of U. S. Provisional Application No. 61/072,292, filed 28 Mar. 2008, and U.S. Provisional Application No. 61/153,508, filed 18 Feb. 2009 (all of which are incorporated herein by reference in their entirety). The present invention constitutes improvements to the methods and systems of the PCT/US2009/038247 application.

More specifically, one embodiment of the present invention comprises an oxygen stream, a carbon dioxide stream, a control fuel stream, a combustion unit, a turbine, and a plenum. The combustion unit is configured to receive and combust the oxygen stream, the carbon dioxide stream, and the control fuel stream to produce a gaseous combustion stream having substantially carbon dioxide and water. The gaseous combustion stream has a temperature of at least 1800 degrees Fahrenheit. The turbine is configured to receive the gaseous combustion stream, expand the gaseous combustion stream, and exhaust the expanded gaseous combustion stream as a turbine discharge stream. The turbine discharge stream has a temperature of at least 1200 degrees Fahrenheit. The plenum is in fluid communication with the turbine for receiving the turbine discharge stream. The plenum is configured to provide a residence time during at least one individual component of the turbine discharge stream reacts chemically towards equilibrium and substantially converts an intermediate product to an equilibrium product.

Another embodiment of the present invention comprises a combustion unit, a turbine, and a steam reformer. The combustion unit is configured to produce a gaseous combustion stream. The turbine is configured to receive the gaseous combustion stream, expand the gaseous combustion stream, and exhaust the expanded gaseous combustion stream as a turbine discharge stream. The turbine discharge stream has a temperature of at least 1200 degrees Fahrenheit. The steam reformer is configured to receive the turbine discharge stream and the control fuel stream, extract heat from the turbine discharge stream, and transfer the heat into a reformer feed stream to generate a reformer product stream.

Yet another embodiment of the present invention comprises the steps of providing an oxygen stream, a carbon dioxide stream, and a control fuel stream; combusting the oxygen stream, the carbon dioxide stream, and the control fuel stream to produce a gaseous combustion stream; expanding the gaseous combustion stream across a turbine to form an expanded gaseous combustion stream; and providing a residence time for the expanded gaseous combustion stream to reach substantial chemical equilibrium, wherein the residence time is provided by a plenum configured to retain the expanded gaseous combustion stream for the residence time.

Still yet another embodiment of the present invention comprises the steps of providing an oxygen stream, a carbon dioxide stream, a control fuel stream, and a reformed control fuel stream; combusting the oxygen stream, the carbon dioxide stream, and the reformed control fuel stream to produce a gaseous combustion stream; expanding the gaseous combustion stream across a turbine to form an expanded gaseous combustion stream; and reforming the control fuel stream to form the reformed control fuel stream using heat extracted from the expanded gaseous combustion stream. The gaseous combustion stream has a temperature of at least 1800 degrees Fahrenheit. The reformed control fuel stream is characterized by an increase in hydrogen as compared to the control fuel stream.

### BRIEF DESCRIPTION OF THE DRAWINGS

The foregoing and other advantages of the present invention may become apparent upon reviewing the following detailed description and drawings of non-limiting examples of embodiments in which:

FIG. 1 illustrates an oxyfuel based system for low emission power generation and hydrocarbon recovery that may be implemented in connection with one or more aspects of the present invention;

FIG. 2 illustrates a turbine and heat recovery steam generator configuration that may be implemented in connection with one or more aspects of the present invention;

FIG. 3 illustrates an oxyfuel based system for low emission power generation and hydrocarbon recovery that may be implemented in connection with one or more aspects of the present invention;

FIG. 4 illustrates an oxyfuel based system for low emission power generation and hydrocarbon recovery according to an embodiment of the present invention;

FIG. 5 illustrates an oxyfuel based system for low emission power generation and hydrocarbon recovery according to another embodiment of the present invention;

FIGS. 6A-B illustrate oxyfuel based systems for low emission power generation and hydrocarbon recovery according to yet other embodiments of the present invention;

FIG. 7 illustrates a flow diagram of a method for use with an oxyfuel gas turbine system according to an embodiment of the present invention;

FIG. 8 illustrates a flow diagram of a method for use with an oxyfuel gas turbine system according to another embodiment of the present invention; and

FIG. 9 shows equilibrium concentrations (mole fractions) of oxygen in the gaseous combustion stream over a range of pressure, temperature and equivalence ratio.

FIG. 10 shows equilibrium concentrations (mole fractions) of carbon monoxide (CO) in the gaseous combustion stream over a range of pressure, temperature and equivalence ratio.

FIG. 11 shows the oxygen concentrations (mole fraction) of oxygen in the gaseous combustion stream over a range of pressure, temperature and equivalence ratio after a finite residence time of 40 ms.

FIG. 12 illustrates the required residence time for the reaction to progress to within 10% of equilibrium for a range of flame temperatures and equivalence ratios.

### DETAILED DESCRIPTION

### DEFINITIONS

As used herein, the “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” and “comprise” are open-ended transition terms used to transition from a subject recited before the term to one or more elements recited after the term, where the element or elements listed after the transition term are not necessarily the only elements that make up of the subject.

As used herein, the terms “containing,” “contains,” and “contain” have the same open-ended meaning as “comprising,” “comprises,” and “comprise.”

As used herein, the terms “having,” “has,” and “have” have the same open-ended meaning as “comprising,” “comprises,” and “comprise.”

As used herein, the terms “including,” “includes,” and “include” have the same open-ended meaning as “comprising,” “comprises,” and “comprise.”

As used herein, the term “equivalence ratio” refers to the mass ratio of fuel to oxygen entering a combustor divided by the mass ratio of fuel to oxygen when the ratio is stoichiometric.

As used herein, a “stoichiometric” mixture is a mixture having a volume of reactants, which is comprised of fuel and oxidizer, and a volume of products formed by combusting the reactants where the entire volume of the reactants is used to form the products

### DESCRIPTION

In the following detailed description section, specific embodiments of the present invention are described in connection with preferred embodiments. However, to the extent that the following description is specific to a particular embodiment or a particular use of the present invention, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

A low emission, high efficiency hydrocarbon recovery process is described in PCT Patent Application PCT/US2009/038247 titled “LOW EMISSION POWER GENERATION AND HYDROCARBON RECOVERY SYSTEMS AND METHODS” which claims the benefit of U.S. Provisional Application No. 61/072,292, filed 28 Mar. 2008, and U.S. Provisional Application No. 61/153,508, filed 18 Feb. 2009.

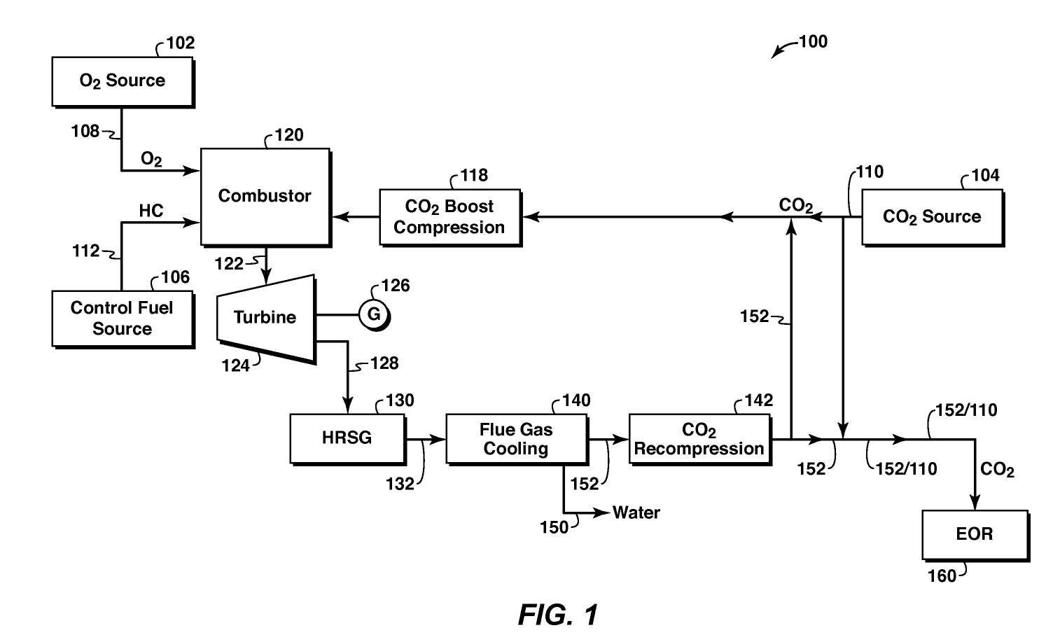

With reference to FIG. 1, an oxyfuel based system 100 for low emission power generation and hydrocarbon recovery that may be implemented in connection with one or more aspects of the present invention is provided. The system 100 generally comprises an oxygen (O2) source 102, a carbon dioxide (CO2 ) source 104 and a control fuel source 106 for generating an oxygen stream 108, a carbon dioxide stream 110 and a control fuel stream 112, such as a hydrocarbon based fuel stream (HC), respectively. In at least one embodiment the CO2 stream 110 may be compressed (e.g., between 12 and 18 barg) using a compressor such as the boost compressor 118. In another embodiment the CO2 stream 110 may, due to the characteristics of the CO2 source, already be at pressure. The streams 108, 110, and 112 are fed to (i.e., received by) a combustion unit 120 and combusted to produce a gaseous combustion stream 122. In general, the gaseous combustion stream 122 includes carbon dioxide (CO2 ) and water (H2O) at a pressure between 12 and 18 bar. More specifically, the gaseous combustion stream 122, in at least one embodiment, may be between 70 and 80 percent CO2. However, the gaseous combustion stream 122 may include any appropriate components at any appropriate concentration(s) and at any appropriate pressure(s) to meet the design criteria of a particular application. Furthermore, the temperature of the gaseous combustion stream 122 is adjusted by the proportion of the CO2 stream 110 applied. For example, in one embodiment, the temperature of the gaseous combustion stream 122 is greater than or equal to 1800 degrees Fahrenheit. In at least one other embodiment the temperature of the gaseous combustion stream 122 is substantially between 1900 and 2700 degrees Fahrenheit. In yet another embodiment, the temperature of the gaseous combustion stream 122 is substantially between 2200 and 2500 degrees Fahrenheit. However, the temperature of the gaseous combustion stream 122 may be any appropriate temperature resulting from the design criteria of a particular application.

In general, the gaseous combustion stream 122 is received by a turbine 124 and is expanded across the turbine 124. In at least one embodiment the turbine 124 is configured such that the expansion of the stream 122 across the turbine 124 generates power, such as electric power generated by an electric generator 126 coupled to the turbine 124. The expanded stream 122 may then be exhausted as a turbine discharge stream 128. In at least one embodiment the turbine discharge stream 128 has a pressure substantially equal to 1 bar. In another embodiment, the turbine discharge stream 128 has a pressure substantially between 1 and 2 bars. However, the turbine discharge stream 128 may have any appropriate pressure resulting from the design criteria of a particular application. Similarly, in at least one embodiment, the turbine discharge stream 128 has a temperature substantially between 1200 and 1800 degrees Fahrenheit. In at least one other embodiment, the turbine discharge stream 128 has a temperature substantially between 1350 and 1700 degrees Fahrenheit. However, the turbine discharge stream 128 may have any appropriate temperature resulting from the design criteria of a particular application.

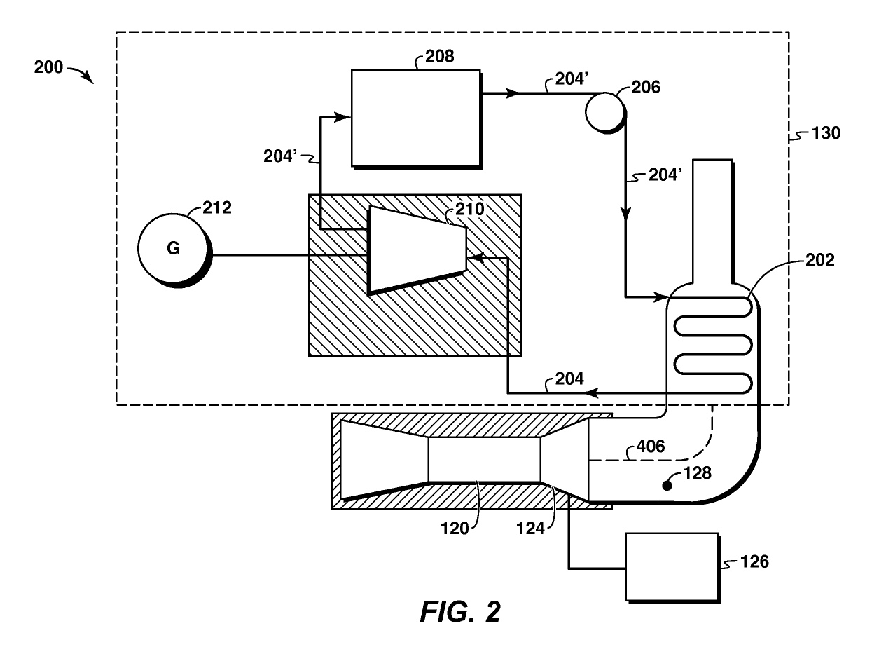

As will be described in subsequent paragraphs, the discharge stream 128 may be implemented in conjunction with one or more additional devices and/or structure to meet the design criteria of a particular application. As shown in FIG. 1, the stream 128 is received by a heat recovery steam generator (HRSG) 130, described in more detail in connection with FIG. 2, for generating electrical power, sometimes referred to as supplemental power. The HRSG generally exhausts/passes a temperature reduced gaseous exhaust stream 132.

Various cooling (e.g., 140) and compression techniques (e.g., 142) may be applied to the gaseous exhaust stream 132 or components of the gaseous exhaust stream 132 to meet the design criteria of a particular application. For example, flue gas cooling 140 may be implemented to separate water (H2O) 150 from the stream 132 such that the concentration of CO2 in the resulting stream 152 is greater than the concentration of CO2 in stream 132. All or a portion of the resultant stream 152 may then be compressed (e.g., via compressor 142) and/or otherwise configured for use in one or more processes such as enhanced oil recovery (EOR) 160. Similarly, all or a portion (e.g., 70-100%) of the resultant stream 152 (compressed or otherwise) may be recirculated as the CO2 stream 110.

FIG. 2 illustrates a turbine 124 and heat recovery steam generator 130 configuration 200 that may be implemented in connection with one or more aspects of the present invention. As shown in FIG. 2, the heat recovery steam generator 130 may comprise a heat exchanger (e.g., steam coil) 202 in contact with the turbine discharge stream 128 for generating steam 204. The steam 204 is expanded across a steam turbine 210 to generate power. The steam turbine discharge stream 204′ is treated further for vapor condensing, water make-up, de-gassing, etc in system 208, which may be a condenser, and pumped (e.g., via pump 206) to high pressure before re-entering the heat exchanger 202. A generator 212 may be coupled to the steam turbine 210 such that the expansion of the steam 204 across the steam turbine 210 generates electrical power.

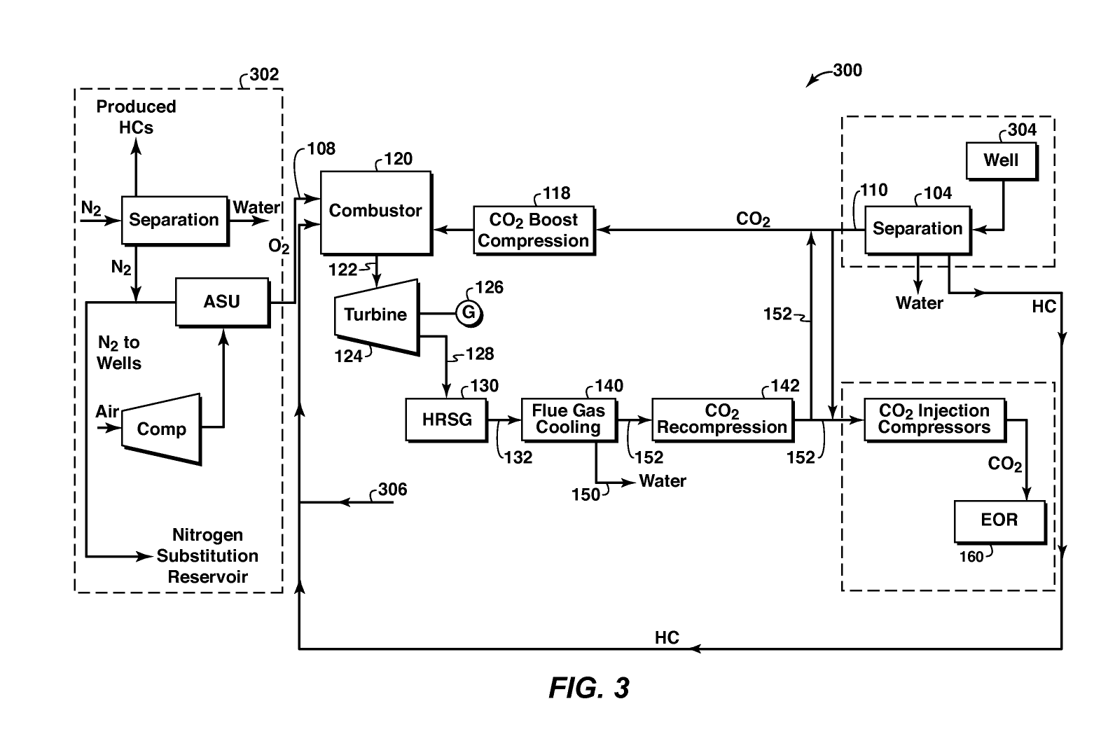

Turning now to FIG. 3, an oxyfuel based system 300 is shown for low emission power generation and hydrocarbon recovery that may be implemented in connection with one or more aspects of the present invention. The system 300 maybe implemented similarly to the system 100 illustrated in connection with FIG. 1 with the addition of exemplary oxygen 102, carbon dioxide 104 and control fuel 106 sources. More specifically, in the embodiment shown in FIG. 3, an Air Separation Unit (ASU) system 302 is used to generate the oxygen stream 108. Nitrogen (N2) may also be generated using the ASU and used in one or more complimentary processes such as nitrogen injection for reservoir pressure maintenance.

Similarly, the control fuel stream 112 may be generated from a carbon dioxide flood reservoir (such as an oil well) 304 and/or a hydrocarbon fuel supply line 306. In at least one embodiment the carbon dioxide stream 110 may also be generated from the oil well 304. It may be appreciated that the system 300 provides the option to utilize one source (e.g., the stream 152) for the carbon dioxide stream 110 during system 300 startup and a second source (e.g., reservoir/oil well 304) during continued system 300 operation or visa-versa.

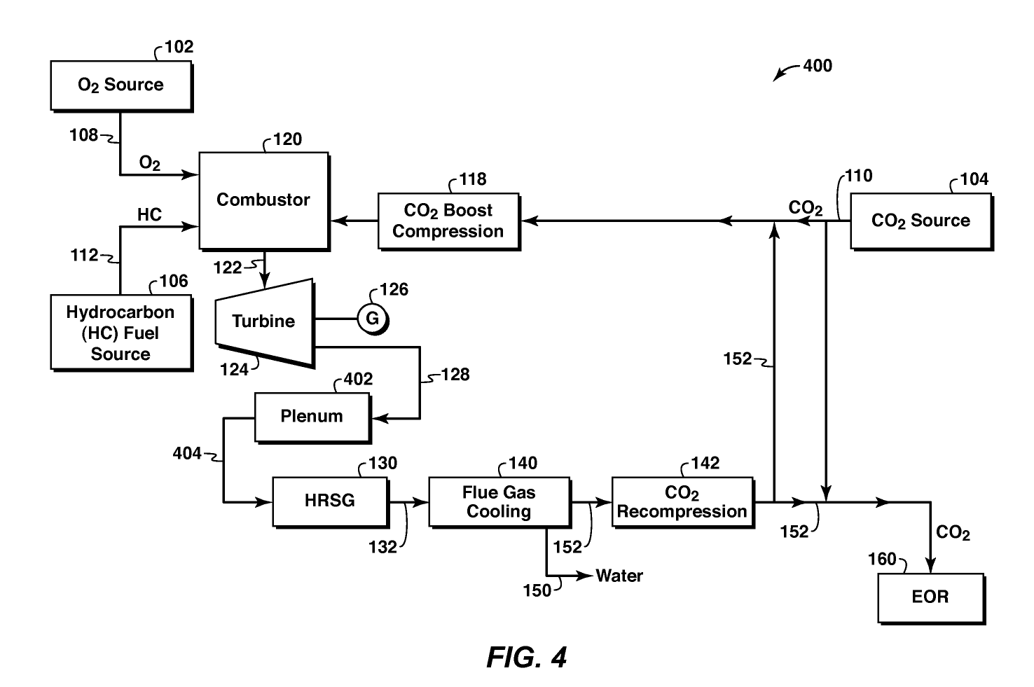

Referring to FIG. 4, a diagram illustrating an oxyfuel based system 400 for low emission power generation and hydrocarbon recovery according to an embodiment of the present invention is shown. The system 400 may be implemented similarly to the system 100 and/or the system 300 with the inclusion of a plenum 402. The plenum 402 is in fluid communication with the turbine 124 and in at least one embodiment may be directly coupled to the turbine 124 for receiving the turbine discharge stream 128. Similarly the plenum 402 may be in fluid communication with a heat recovery steam generator. The plenum 402 is configured to provide a residence time during which individual components of the turbine discharge stream 128 may continue to react chemically.

In conventional non-oxyfuel high-pressure combustors used in power generating applications, the gases only reside in a combustor for a short period time (e.g., 40 ms) before entering a turbine. Because the reaction rate declines with temperature, the reaction is effectively “frozen” as the gases cool through the turbine's expander. In such a system the reaction is not able to reach equilibrium and the chemistry does not continue at measurable rates downstream in the system. The present invention configures the oxyfuel combustion system temperature, pressure and gas composition to generate a higher temperature turbine discharge stream that is generally still of a sufficient temperature to promote chemical reactions. The plenum 402 claimed in the present invention is designed and implemented to provide a suitable residence time during which individual components of a turbine discharge stream (e.g., 128) may continue to react until, upon exiting the plenum 402, the individual components have reached, or substantially reached, a desired reaction state. The resultant plenum exhaust stream 404 may then be utilized in subsequent processes (e.g., EOR) to meet a specified compositional design criteria of a pipeline or other particular application.

In one embodiment, the residence time is predetermined such that at least one individual component of the turbine discharge stream 128 continues to react chemically until the reaction reaches substantial equilibrium (i.e., one or more intermediate product is substantially converted to an equilibrium product). In at least one embodiment, substantial equilibrium may be considered the chemical reaction point at which the concentration of an individual component (e.g., oxygen, carbon monoxide, a hydrocarbon intermediate species, an unburned hydrocarbon intermediate species, formaldehyde, and/or the like) of the turbine discharge stream 128 becomes less than 10% greater than an equilibrium concentration of the individual component.

In yet another embodiment, the residence time maybe predetermined such that at least a predetermined percentage (e.g., 50%, 75%, 90%, etc.) of an individual component (e.g., oxygen, carbon monoxide, a hydrocarbon intermediate species, an unburned hydrocarbon intermediate species, formaldehyde, and/or the like) of the turbine discharge stream 128 at an exit of the turbine 124 is converted to an equilibrium product at an exit of the plenum 402.

Alternatively, the residence time may be predetermined such that the at least one individual component of the turbine discharge stream 128 reacts chemically until the individual component(s) is suitable for use with an Enhanced Oil Recovery process. In at least one such embodiment, the individual components may include oxygen and carbon monoxide, and the components may be determined to be suitable for use with an Enhanced Oil recovery Process when the oxygen has a concentration equal to or less than 10 parts-per-million and the carbon monoxide has a concentration equal to or less than 1000 parts-per-million.

One or more embodiments of the present invention may include a plenum 402 that provides a residence time substantially between 0.1 and 10 seconds. In another embodiment, the plenum 402 may provide a residence time substantially between 0.1 and 2 seconds. In yet another embodiment, the plenum 402 may provide a residence time greater than 1 second. However, the plenum 402 may be configured to provide any appropriate residence time to meet the design criteria of a particular application.

It may be understood from the present disclosure that residence time is essentially a function of the velocity of the gas passing through the plenum 402 and the volume of the plenum 402. As such, the volume of the plenum 402 may be determined to effectuate a desired residence time knowing the density of the turbine discharge stream 128. In at least one embodiment, the plenum 402 has a constant cross-sectional area and a center line length 406 (illustrated in FIG. 2) substantially between 10 and 30 meters. In yet another embodiment, the plenum 402 has a constant cross-sectional area and a center line length 406 greater than or equal to 30 meters. However, the plenum may have any appropriate volume, shape (including irregular shapes) and/or center line length 406 to meet the design criteria of a particular application.

As such, FIG. 4 represents, inter alia, an embodiment 400 of the present invention wherein a plenum (e.g., 402) is designed and implemented to provide a suitable residence time during which individual components of a turbine discharge stream (e.g., 128) may continue to react until they have reached (or substantially reached) a desired chemical composition (i.e., reaction state).

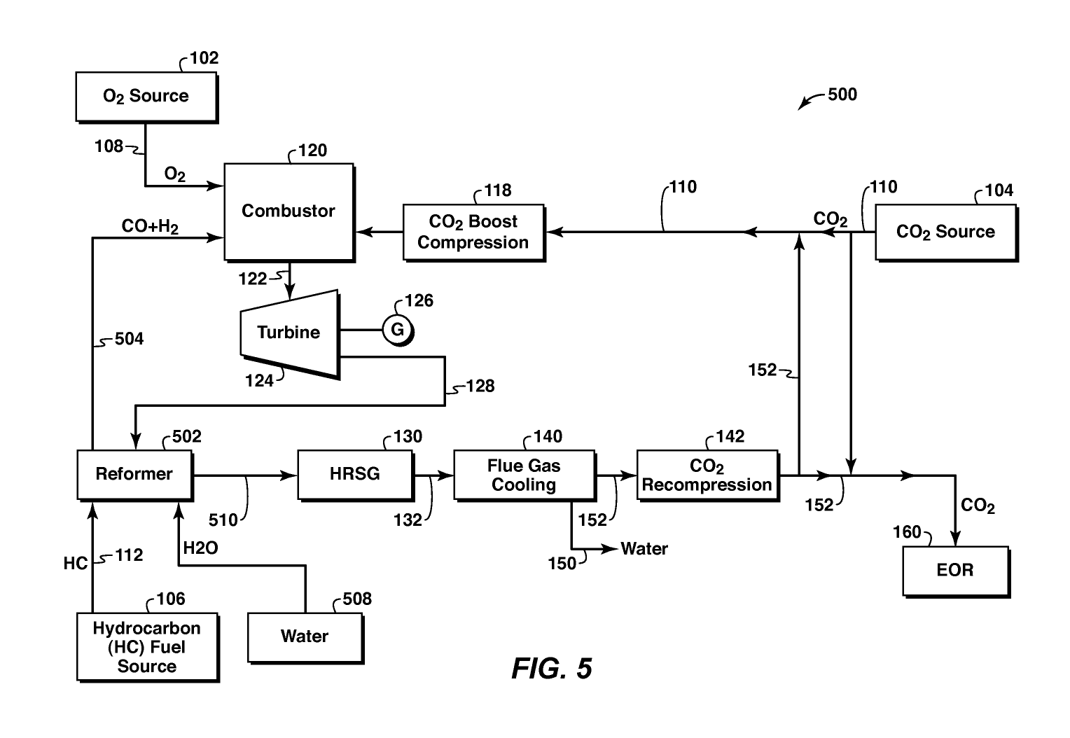

FIG. 5 illustrates another oxyfuel based system 500 which may be implemented similarly to the systems previously discussed (e.g., 100, 300 and 400). More specifically, the system 500 includes a steam reformer 502 which may, itself, comprise a heat exchanger and a catalyst. The steam reformer 502 may be any suitable type of reformer to meet the design criteria of a particular application; such as a steam reformer or an auto thermal reformer. The steam reformer 502 is configured to receive the turbine discharge stream 128, at least a portion of the control fuel stream 112, and a water stream 506 from a water source 508. In general, inputs to the reformer 502 may be referred to as reformer feed streams and may, in at least one embodiment, include steam and/or carbon dioxide. The heat from the turbine discharge stream 128 drives the endothermic, catalytic steam reforming reaction between the water stream 506 and the control fuel stream 112 (e.g., methane in the control fuel stream 112) to generate the reformed control fuel stream 504. In general, outputs of the reformer 502 may be referred to as reformer product streams. In one embodiment, the reformer product stream is further shifted and separated to generate a hydrogen-rich stream and/or a carbon dioxide-rich stream (not shown). The hydrogen-rich stream may be suitable for sale or for piping to a different process.

The reformed control fuel stream 504 is generally characterized by an increase in hydrogen as compared to the control fuel stream 112 and in one embodiment is substantially comprised of hydrogen and carbon monoxide. The reformed control fuel stream 504 is then fed to the combustion unit 120 in place of the control fuel stream 112 of FIG. 1. In at least one embodiment the reformed control fuel stream 504 contains some of the initial hydrocarbon fuel from the fuel control stream 112, a portion of the hydrogen-rich stream, a portion of the carbon dioxide-rich stream, and/or a combination thereof.

In general the steam reformer 502 is in fluid communication with the turbine 124 and in at least one embodiment the reformer 502 may be directly coupled to the turbine 124. In addition, one or more embodiments of the present invention may include a steam reformer 502 in fluid communication with and located upstream from a heat recovery steam generator 130. That is, the heat recovery steam generator 130 may receive the reformer exhaust gas 510.

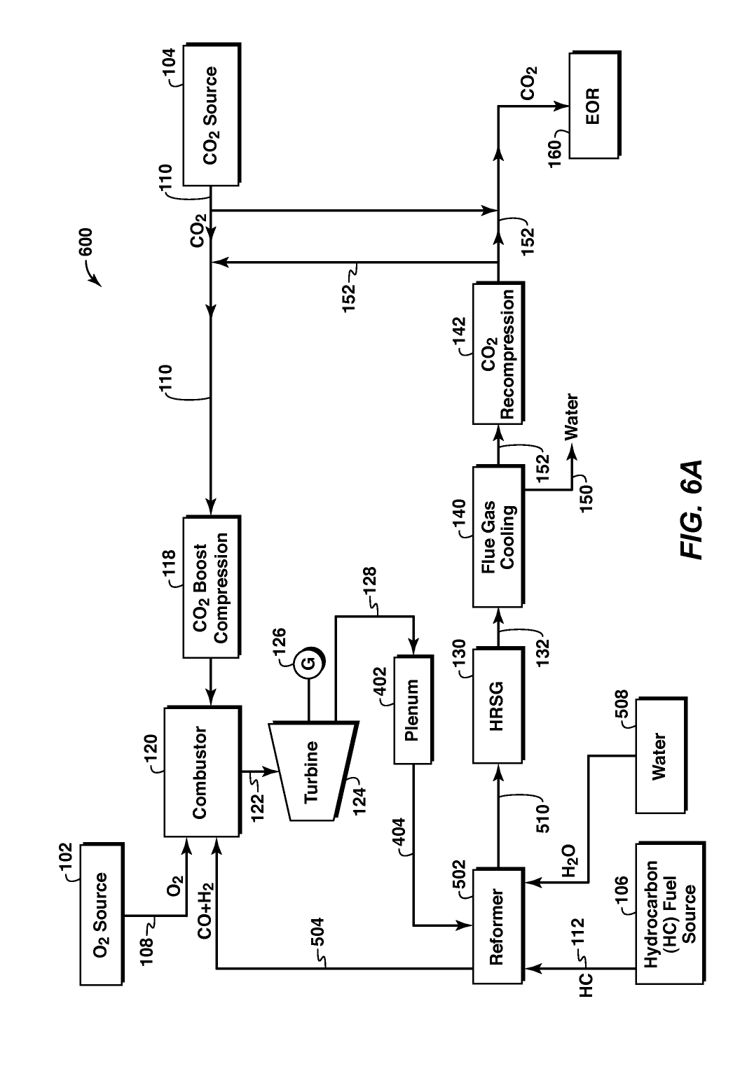

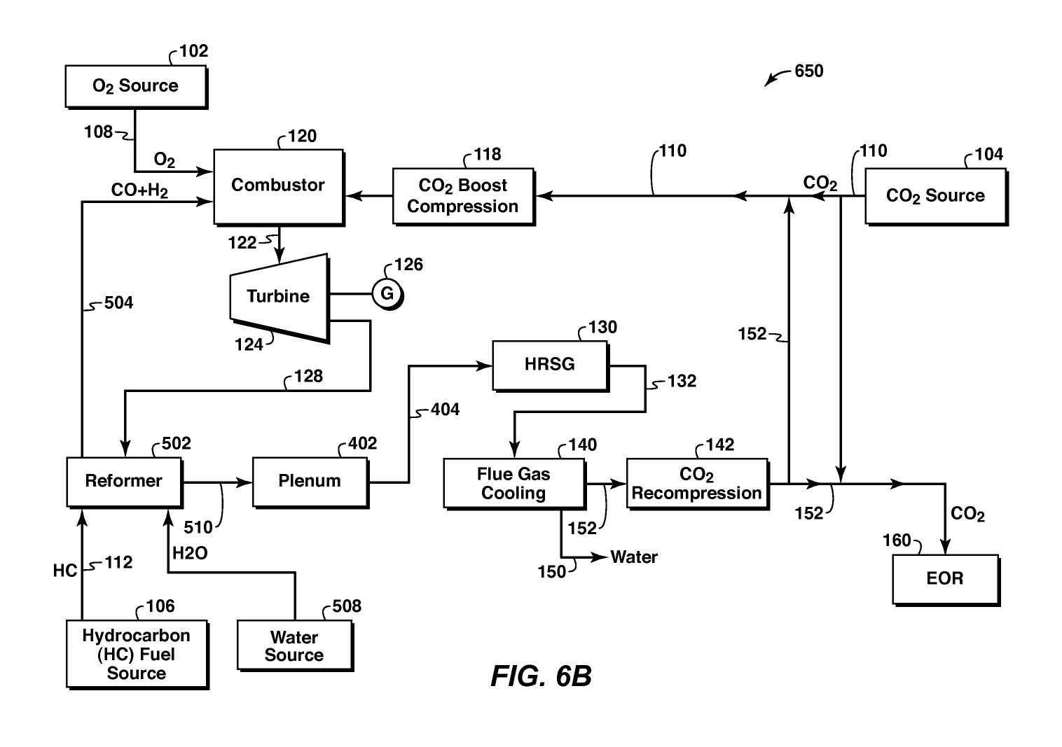

FIG. 6A illustrates yet another oxyfuel based system 600 which may be implemented similarly to the systems previously discussed (e.g., 100, 300, 400 and 500). More specifically, the system 600 includes a plenum 402 and a steam reformer 502. As illustrated, the plenum 402 may be in fluid communication with the turbine 124 and may act as previously described in connection with the system 400. Similarly, the reformer 502, which may itself comprise a heat exchanger and a catalyst, may be in fluid communication with the plenum 402 and may be configured to use heat from the plenum exhaust stream 404 to reform, for example, methane in the control fuel stream 112 and water in the water stream 506 into hydrogen and carbon monoxide. In one or more embodiments, the reformer exhaust gas 510 may then be fed to a heat recovery steam generator 130, located down stream from the reformer 502.

As such, in at least one embodiment the plenum 402, described in connection with the system 400, and the steam reformer 502, described in connection with the system 500, may be advantageously implemented in a single system (e.g., 600) to meet the design criteria of a particular application.

FIG. 6B illustrates yet another oxyfuel based system 650 which may be implemented similarly to the system 600. More specifically, the system 650 includes a plenum 402 coupled downstream from the steam reformer 502 and a heat recovery steam generator 130 located down stream of the plenum 402. In such an embodiment the reformer 502 may be in direct fluid communication and/or directly coupled with the turbine 124. In at least one embodiment, a distance between the reformer 502 and a discharge nozzle (not shown) of the turbin 124 is less than 5 meters. Similarly, the residence time between the reformer 502 and the discharge nozzle on the turbine 124 may be less than 0.1 second. However, any appropriate distance and/or any appropriate residence time may be implemented in the system 650 to meet the design criteria of a particular application.

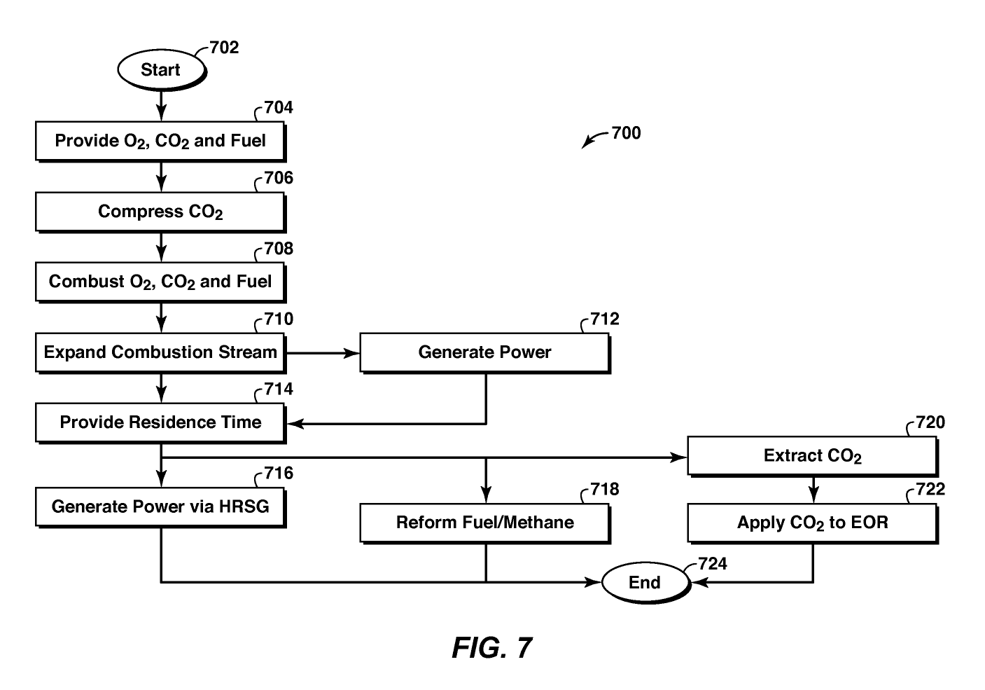

Turning now to FIG. 7, a flow diagram is provided of a method 700 for use with an oxyfuel gas turbine system according to an embodiment of the present invention. The method 700 may be advantageously implemented in connection with the systems 100, 300, 400, 500, 600 and/or 650 described previously in connection with FIGS. 1, 3, 4, 5 and 6A (respectively), and/or any appropriate system to meet the design criteria of a particular application. The method 700 generally includes a plurality of blocks or steps (e.g., 702, 704, 706, and the like) that may be performed serially. As will be appreciated by one of ordinary skill in the art, the order of the steps shown in FIG. 7 is exemplary and the order of one or more steps may be modified within the spirit and scope of the present invention. Additionally, the steps of the method 700 may be performed in at least one non-serial (or non-sequential) order, and one or more steps may be omitted to meet the design criteria of a particular application. Block 702 represents an entry point into the method 700.

Block 704 represents the step of providing an oxygen stream (e.g., 108), a carbon dioxide stream (e.g., 110), and a control fuel stream (e.g., 112).

Block 706 represents an optional step of compressing the carbon dioxide (CO2 ). In at least one embodiment, CO2 may be compressed to between 12 and 18 barg. However, the CO2 may be compressed to any appropriate pressure to meet the design criteria of a particular application. In at least one embodiment, the pressure of the CO2 at the combustor (e.g., 120) may be substantially similar to the pressure of the CO2 at the source (e.g., 104). In such an embodiment, post source compression may be unnecessary.

Block 708 represents the step of combusting the oxygen stream, the carbon dioxide stream, and the control fuel stream to produce a gaseous combustion stream (e.g., 122). In general, the gaseous combustion stream includes CO2 and water at a pressure between 12 and 18 bar. More specifically, the gaseous combustion stream may be between 70 and 80 percent CO2. However, the gaseous combustion stream may include any appropriate components at any appropriate concentration(s) and at any appropriate pressure(s) to meet the design criteria of a particular application. In one embodiment, the temperature of the gaseous combustion stream is greater than or equal to 1800 degrees Fahrenheit. In another embodiment the temperature of the gaseous combustion stream is substantially between 1900 and 2700 degrees Fahrenheit. In yet another embodiment, the temperature of the gaseous combustion stream is substantially between 2200 and 2500 degrees Fahrenheit. However, the temperature of the gaseous combustion stream may be any appropriate temperature to meet the design criteria of a particular application.

Block 710 represents the step of expanding the gaseous combustion stream across a turbine (e.g., 124) to form an expanded gaseous combustion stream (e.g., turbine discharge stream 128). The temperature of the expanded gaseous combustion stream is higher than the exhaust temperature of a similar non-oxyfuel gas turbine system. In at least one embodiment, the expanded gaseous combustion stream has a temperature substantially between 1200 and 1800 degrees Fahrenheit. In at least one other embodiment, the expanded gaseous combustion stream has a temperature substantially between 1350 and 1700 degrees Fahrenheit. However, the expanded gaseous turbine stream may be of any appropriate temperature resulting from the design criteria of a particular application.

Block 712 represents the optional step of generating power from the expansion of the gaseous stream across the turbine (i.e., Block 710).

Block 714 represents the step of providing a residence time for the expanded gaseous combustion stream to reach a desired chemical state, such as substantial chemical equilibrium. In at least one embodiment, the residence time is provided by a plenum (e.g., 402) configured to retain the expanded gaseous combustion stream for the residence time. As discussed in connection with FIG. 4, the plenum may be configured to retain the expanded gaseous combustion stream for any appropriate residence time such that a desired chemical state (e.g., equilibrium, substantial equilibrium, composition suitable for an Enhanced Oil Recovery process, etc.) is achieved. For example, in at least one embodiment, the plenum may have a center line length substantially between 10 and 30 meters. In another embodiment, the plenum may have a center line length greater than or equal to 30 meters. Similarly, the residence time in one embodiment may be substantially between 0.10 and 10 seconds. In another embodiment the residence time may be substantially between 0.10 and 2 seconds. In yet another embodiment the residence time may be greater than or equal to 1 second. From Block 714 the method 700 may then fall through to any number (or none) of optional steps such as one or more of Blocks 716, 718, 720 and/or 722.

Block 716 represents the optional step of generating power, using a heat recovery steam generator (e.g., 130), from the expanded gaseous combustion stream after the step of providing a residence time (i.e., Block 714).

Block 718 represents the optional step of reforming the control fuel stream (e.g., methane) using heat extracted from the expanded gaseous combustion stream into, for example, Hydrogen and Carbon Monoxide.

Last, blocks 720 and 722 represent the optional steps of extracting carbon dioxide (e.g., from the gaseous combustion stream); and applying the carbon dioxide in an Enhanced Oil Recovery process, respectively.

Block 724 represents and exit from the method 700.

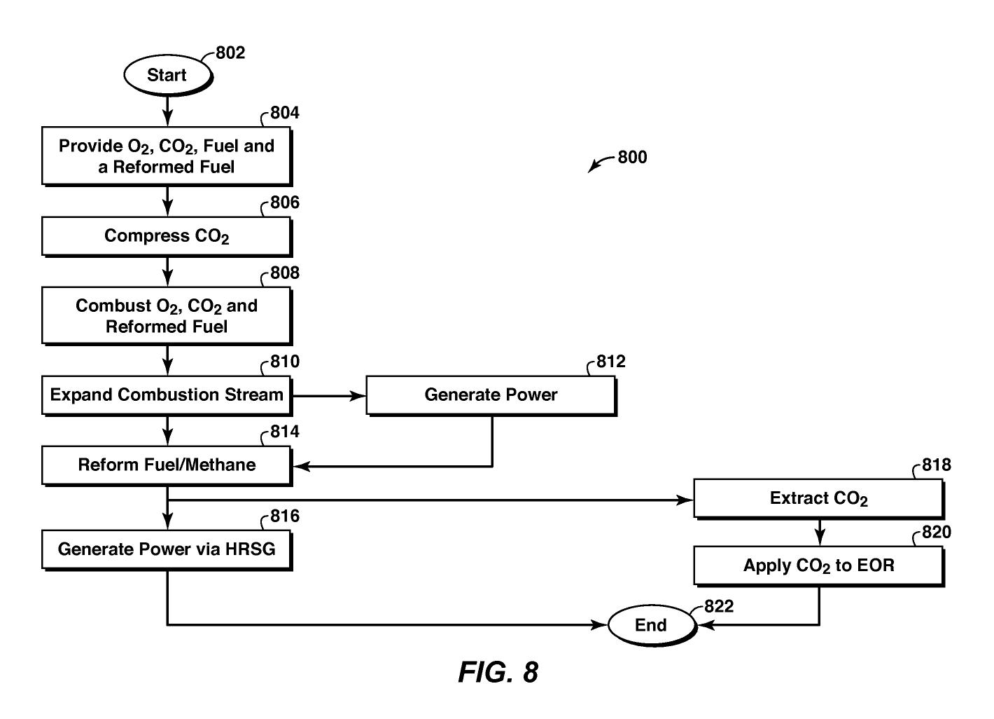

At FIG. 8, a flow diagram is provided of a method 800 for use with an oxyfuel gas turbine system according to another embodiment of the present invention. The method 800 may be advantageously implemented in connection with the systems 100, 300, 400, 500, 600 and/or 650 described previously in connection with FIGS. 1, 3, 4, 5 and 6A (respectively), and/or any appropriate system to meet the design criteria of a particular application. The method 800 generally includes a plurality of blocks or steps (e.g., 802, 804, 806, and the like) that may be performed serially. As will be appreciated by one of ordinary skill in the art, the order of the steps shown in FIG. 8 is exemplary and the order of one or more steps may be modified within the spirit and scope of the present invention. Additionally, the steps of the method 800 may be performed in at least one non-serial (or non-sequential) order, and one or more steps may be omitted to meet the design criteria of a particular application. Block 802 represents an entry point into the method 800.

Block 804 represents the step of providing an oxygen stream (e.g., 108), a carbon dioxide stream (e.g., 110), a control fuel stream (e.g., 112), and a reformed control stream (e.g., 504).

Block 806 represents an optional step of compressing the carbon dioxide (CO2 ). In at least one embodiment, CO2 may be compressed to between 12 and 18 barg. However, the CO2 may be compressed to any appropriate pressure to meet the design criteria of a particular application. In at least one embodiment, the pressure of the CO2 at the combustor (e.g., 120) may be substantially similar to the pressure of the CO2 at the source (e.g., 104). In such an embodiment, post source compression may be unnecessary.

Block 808 represents the step of combusting the oxygen stream, the carbon dioxide stream, and the reformed control fuel stream to produce a gaseous combustion stream (e.g., 122). In general, the gaseous combustion stream includes CO2 and water (H2O) at a pressure between 12 and 18 bar. More specifically, the gaseous combustion stream may be between 70 and 80 percent CO2. However, the gaseous combustion stream may include any appropriate components at any appropriate concentration(s) and at any appropriate pressure(s) to meet the design criteria of a particular application. In one embodiment, the temperature of the gaseous combustion stream is greater than or equal to 1800 degrees Fahrenheit. In at least one other embodiment the temperature of the gaseous combustion stream is substantially between 1900 and 2700 degrees Fahrenheit. In yet another embodiment, the temperature of the gaseous combustion stream is substantially between 2200 and 2500 degrees Fahrenheit. However, the temperature of the gaseous combustion stream may be any appropriate temperature to meet the design criteria of a particular application.

Block 810 represents the step of expanding the gaseous combustion stream across a turbine (e.g., 124) to form an expanded gaseous combustion stream (e.g., turbine discharge stream 128). The temperature of the expanded gaseous combustion stream is higher than the exhaust temperature of a similar non-oxyfuel gas turbine system. In at least one embodiment, the expanded gaseous combustion stream has a temperature substantially between 1200 and 1800 degrees Fahrenheit. In at least one other embodiment, the expanded gaseous combustion stream has a temperature substantially between 1350 and 1700 degrees Fahrenheit. However, the expanded gaseous turbine stream may be of any appropriate temperature resulting from the design criteria of a particular application.

Block 812 represents the optional step of generating power from the expansion of the gaseous stream across the turbine (i.e., Block 810).

Block 814 represents the step of reforming the control fuel stream, using heat extracted from the expanded gaseous combustion stream, to form the reformed control fuel stream. In general, the reformed control fuel stream may be characterized by an increase in hydrogen as compared to the control fuel stream. From Block 814 the method 800 may fall through to any number (or none) of optional steps such as one or more of Blocks 816, 818, and/or 820.

Block 816 represents the optional step of generating power, using a Heat recovery steam generator (e.g., 130), from the expanded gaseous combustion stream after the step of reforming (i.e., Block 814).

Blocks 818 and 820 represent the optional steps of extracting carbon dioxide (e.g., from the gaseous combustion stream); and applying the carbon dioxide in an Enhanced Oil Recovery process, respectively.

Block 822 represents and exit from the method 800.

### Simulations

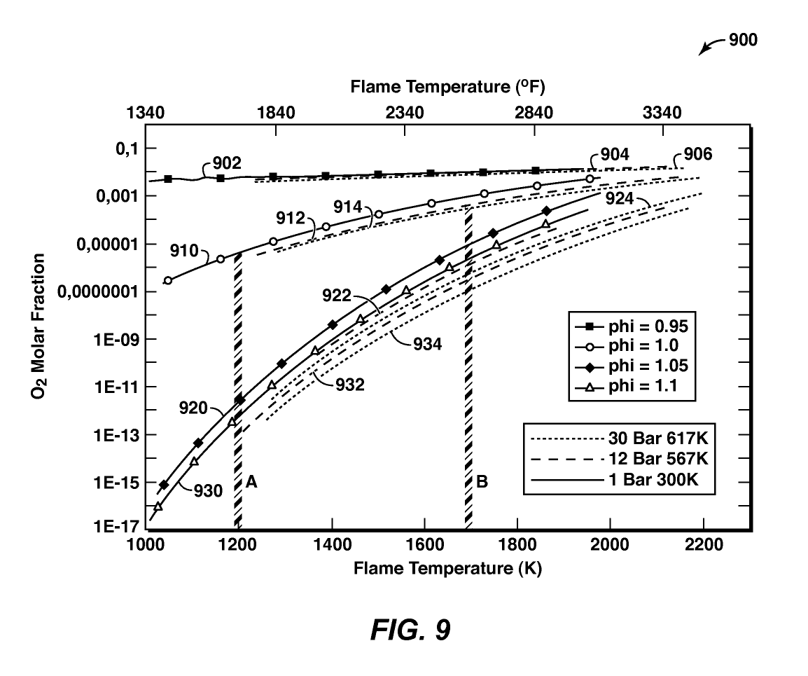

Turning now to FIGS. 9, 10, 11 and 12, a number of graphs representing simulation results are provided. It should be appreciated that the information embodied in these figures and the corresponding text which follows is offered to provide additional insight into, but not to limit, the present invention.

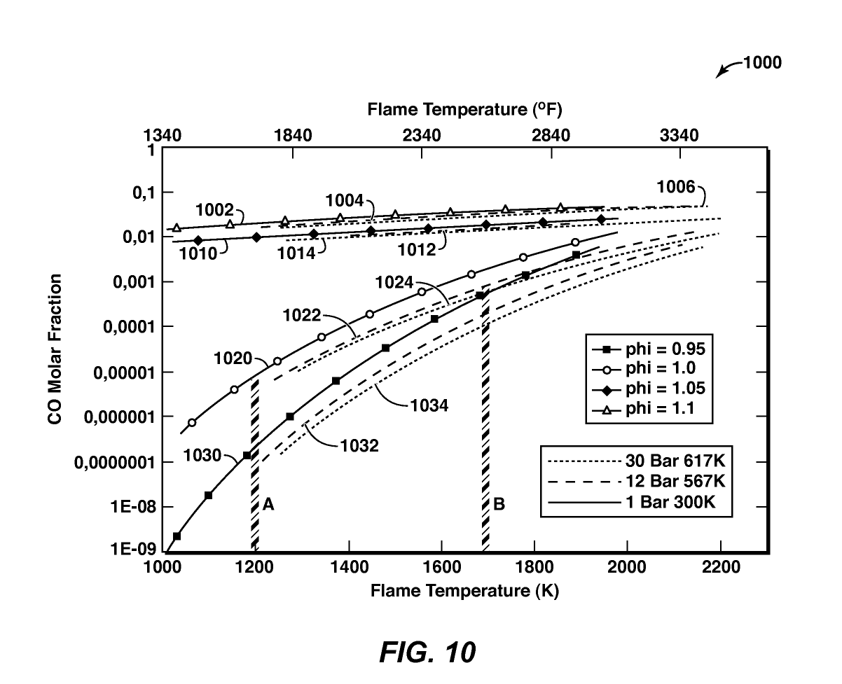

Taken together, FIGS. 9 and 10 illustrate equilibrium molar fractions of O2 and CO, respectively, for O2/methane combustion in a CO2 stream at a range of flame temperatures, pressures (i.e., 1 bar represented by the solid lines, 12 bars represented by the dashed lines, and 30 bars represented by the dotted lines), and equivalence ratios (i.e., methane to O2 ratios of 0.95, 1, 1.05 and 1.1). In a general sense, equilibrium composition refers to the state where the concentration of all species are constant over time. The composition of a mixture at equilibrium is dependent upon the temperature, pressure and composition of the reactants. In the case of an oxyfuel combustor where the CO2 stream will be used for EOR or transported in a pipeline, it is desirable to have the smallest concentrations of O2 and CO possible. The graphs of FIGS. 9 and 10 illustrate the equilibrium, and therefore lowest possible, O2 and CO concentrations when the reactions can progress to an equilibrium state.

With regard to the graph 900 of FIG. 9, plot 902 represents an equivalence ratio of 0.95 at 1 bar of pressure, 904 represents an equivalence ratio of 0.95 at 12 bars of pressure, and 906 represents an equivalence ratio of 0.95 at 30 bars of pressure. Similarly, plot 910 represents an equivalence ratio of 1 at 1 bar of pressure, 912 represents an equivalence ratio of 1 at 12 bars of pressure, and 914 represents an equivalence ratio of 1 at 30 bars of pressure. Plot 920 represents an equivalence ratio of 1.05 at 1 bar of pressure, 922 represents an equivalence ratio of 1.05 at 12 bars of pressure, and 924 represents an equivalence ratio of 1.05 at 30 bars of pressure. Last, plot 930 represents an equivalence ratio of 1.1 at 1 bar of pressure, 932 represents an equivalence ratio of 1.1 at 12 bars of pressure, and 934 represents an equivalence ratio of 1.1 at 30 bars of pressure.

With regard to graph 1000 of FIG. 10, plot 1002 represents an equivalence ratio of 1.1 at 1 bar of pressure, 1004 represents an equivalence ratio of 1.1 at 12 bars of pressure, and 1006 represents an equivalence ratio of 1.1 at 30 bars of pressure. Similarly, plot 1010 represents an equivalence ratio of 1.05 at 1 bar of pressure, 1012 represents an equivalence ratio of 1.05 at 12 bars of pressure, and 1014 represents an equivalence ratio of 1.05 at 30 bars of pressure. Plot 1020 represents an equivalence ratio of 1 at 1 bar of pressure, 1022 represents an equivalence ratio of 1 at 12 bars of pressure, and 1024 represents an equivalence ratio of 1 at 30 bars of pressure. Last, plot 1030 represents an equivalence ratio of 0.95 at 1 bar of pressure, 1032 represents an equivalence ratio of 0.95 at 12 bars of pressure, and 1034 represents an equivalence ratio of 0.95 at 30 bars of pressure.

As previously mentioned, a complicating factor with conventional high-pressure combustors used in power generating devices, such as gas turbines, is that the gaseous combustion stream only resides in the combustor for a relatively short time, on the order of 40 ms, before entering the turbine. As a result, the composition is “frozen” because the reaction is quenched as the gas cools through the turbine's expander. There is not enough energy (e.g. low temperature) to allow reactions to progress toward equilibrium at a measurable rate.

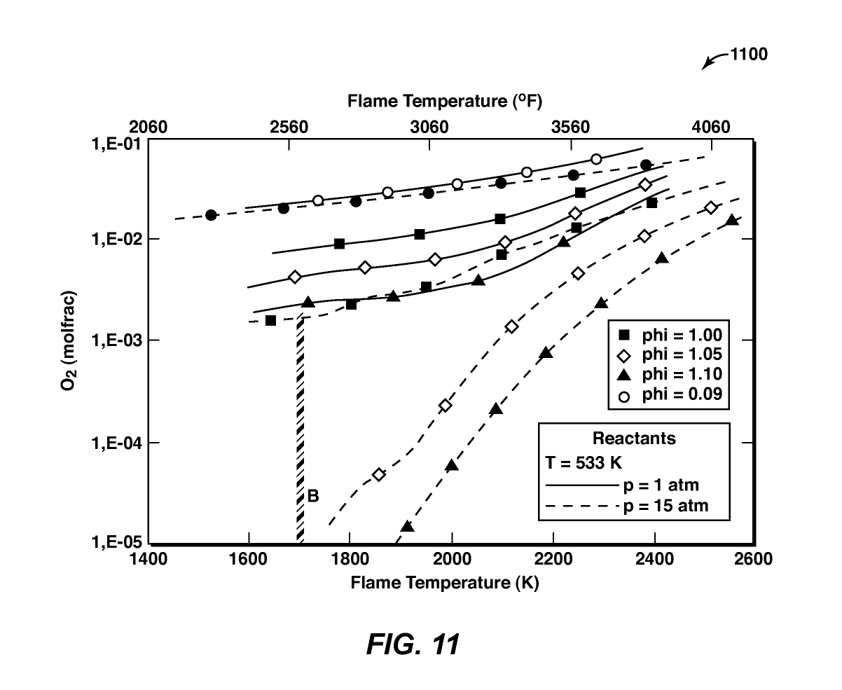

FIG. 11 illustrates the magnitude of the difference between the frozen O2 concentration and the equilibrium concentration. FIG. 11 indicates that at 1700 K and an equivalence ratio of 1 at 1 atm, the O2 mole fraction is frozen at approximately 0.008. In comparison, the equilibrium O2 mole fraction for the same conditions in FIG. 9 is approximately 8 times lower at 0.001.

In the proposed configuration of the oxyfuel gas turbine the temperature, pressure and reactant composition are configured to produce a turbine discharge stream with a temperature that is high enough to drive continued reaction toward equilibrium over a calculated residence time. For example, a potential turbine inlet temperature of 1750 K (2690 F) is marked by the line labeled “B” on graph 900, 1000 and 1100. Line “B” indicates an O2 equilibrium level of the order of 300-500 ppm; however, Line B of graph 1100 indicates that the realistic O2 concentration after 40 ms are up to an order of magnitude higher than the equilibrium levels shown at corresponding Line B of graph 900. It may be noted that the O2 level at Line B of graph 1100 is greater than one thousand ppm (12 bar, phi=1.0). Such a concentration of O2 is generally unacceptably high for pipeline (i.e., down hole) applications. After expansion across the turbine, the turbine discharge temperature is expected to be on the order or 1200 K. If a plenum is built into the system that allows the chemistry to progress toward equilibrium, the O2 mole fraction, as indicated by line “A” in 1000, will be less than 0.00001 (10 ppm).

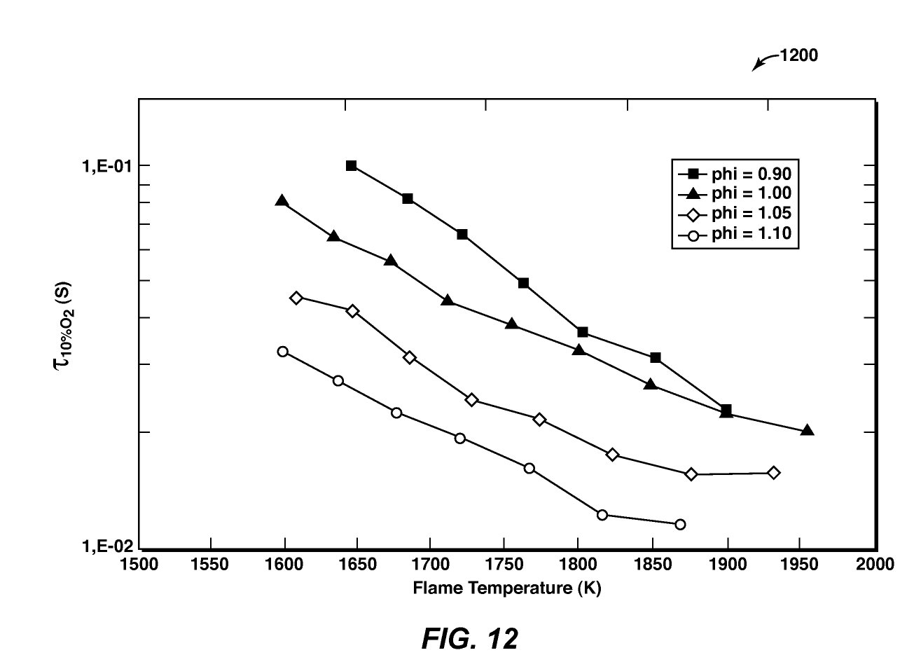

Graph 1200 of FIG. 12 illustrates that longer residence times may provide lower O2 concentrations. Graph 1200 plots the time required (τ10%) for the O2 to reduce from its peak level in the flame to 10% of that peak level. For example, at a turbine discharge temperature of 1200 K as, noted by Line A of graph 900, the residence time requirement may exceed 1 second.

The present invention may be susceptible to various modifications and alternative forms and the exemplary embodiments discussed above have been shown only by way of example. It should be understood that the invention is not intended to be limited to the particular embodiments disclosed herein. Indeed, the present invention includes all alternatives, modifications, and equivalents falling within the true spirit and scope of the appended claims.

What is claimed is:

1. An oxyfuel gas turbine system comprising:
an oxygen stream;
a carbon dioxide stream;
a control fuel stream;
a combustion unit configured to receive the oxygen stream, the carbon dioxide stream, and the control fuel stream, and combust the control fuel stream, the carbon dioxide stream, and the oxygen stream to produce a gaseous combustion stream having substantially carbon dioxide and water, wherein the gaseous combustion stream has a temperature of at least 1800 degrees Fahrenheit;
a turbine configured to receive the gaseous combustion stream, expand the gaseous combustion stream, and exhaust the expanded gaseous combustion stream as a turbine discharge stream, wherein the turbine discharge stream has a temperature of at least 1200 degrees Fahrenheit; and
a plenum in fluid communication with the turbine for receiving the turbine discharge stream, wherein the plenum is configured to provide a residence time during which at least one individual component of the turbine discharge stream reacts chemically towards equilibrium and substantially converts an intermediate product to an equilibrium product.

2. The system of claim 1 wherein the turbine is configured to generate power when the gaseous combustion stream is expanded.

3. The system of claim 1 wherein at least a portion of the carbon dioxide from the gaseous combustion stream is used for Enhanced Oil Recovery.

4. The system of claim 1 wherein the residence time is predetermined such that the individual component of the turbine discharge stream reacts chemically until a concentration of the individual component is less than 10% greater than an equilibrium concentration of the individual component.

5. The system of claim 4 wherein the individual component is oxygen.

6. The system of claim 4 wherein the individual component is carbon monoxide.

7. The system of claim 4 wherein the individual component is a hydrocarbon intermediate species.

8. The system of claim 7 wherein the hydrocarbon intermediate species is an unburned hydrocarbon.

9. The system of claim 8 wherein the unburned hydrocarbon is formaldehyde.

10. The system of claim 1 wherein the residence time is predetermined such that at least a predetermined percentage of the individual component of the turbine discharge stream at an exit of the turbine is converted to an equilibrium product at an exit of the plenum.

11. The system of claim 10 wherein the predetermined percentage is 50%.

12. The system of claim 10 wherein the predetermined percentage is 75%.

13. The system of claim 10 wherein the predetermined percentage is 90%.

14. The system of claim 10 wherein the individual component is oxygen.

15. The system of claim 10 wherein the individual component is carbon monoxide.

16. The system of claim 10 wherein the individual component is a hydrocarbon intermediate species.

17. The system for claim 16 wherein the hydrocarbon intermediate species is an unburned hydrocarbon.

18. The system for claim 17 wherein the unburned hydrocarbon is formaldehyde.

19. The system of claim 1 wherein the residence time is predetermined such that the individual component of the turbine discharge stream reacts chemically until the individual component is suitable for use with an Enhanced Oil Recovery process.

20. The system of claim 19 wherein the individual component is oxygen and the oxygen has a concentration equal to or less than 10 parts-per-million.

21. The system of claim 19 wherein the individual component is carbon monoxide and the carbon monoxide has a concentration equal to or less than 1000 parts-per-million.

22. The system of claim 1 wherein the residence time is substantially between 0.1 and 10 seconds.

23. The system of claim 1 wherein the residence time is substantially between 0.1 and 2 seconds.

24. The system of claim 1 wherein the residence time is greater than or equal to 1 second.

25. The system of claim 1 wherein the plenum has a center line length substantially between 10 and 30 meters.

26. The system of claim 1 wherein the plenum has a center line length greater than or equal to 30 meters.

27. The system of claim 1 wherein the pressure of the gaseous combustion stream is substantially between 12 and 18 bar prior to being acted upon by the turbine.

28. The system of claim 1 wherein the temperature of the gaseous combustion stream is substantially between 1900 and 2700 degrees Fahrenheit.

29. The system of claim 1 wherein the temperature of the gaseous combustion stream is between 2200 and 2500 degrees Fahrenheit.

30. The system of claim 1 wherein the gaseous combustion stream is substantially between 70 and 80 percent carbon dioxide.

31. The system of claim 1 wherein the pressure of the turbine discharge stream is substantially 1 bar.

32. The system of claim 1 wherein the pressure of the turbine discharge stream is substantially between 1 and 2 bar.

33. The system of claim 1 wherein the temperature of the turbine discharge stream is between 1200 and 1800 degrees Fahrenheit.

34. The system of claim 1 wherein the temperature of the turbine discharge stream is between 1350 and 1700 degrees Fahrenheit.

35. The system of claim 1 wherein the carbon dioxide stream is compressed in one or more compressors prior to being received by the combustion unit.

36. The system of claim 1 wherein the plenum is in fluid communication with a heat recovery steam generator.

37. The system of claim 36 wherein the heat recovery steam generator is configured to generate power.

38. The system of claim 1 wherein the plenum is directly coupled to the turbine.

39. The system of claim 1 wherein the oxygen stream is generated using an Air Separation Unit.

40. The system of claim 1 wherein the control fuel stream is generated from at least one of a carbon dioxide flood reservoir and a hydrocarbon fuel supply pipeline.

41. The system of claim 1 wherein the carbon dioxide stream comprises between 70 and 100 percent of the carbon dioxide from the gaseous combustion stream.

42. The system of claim 1 wherein the carbon dioxide stream is generated from an oil well.

43. The system of claim 1 wherein the carbon dioxide stream is generated primarily from a first source during startup of the oxyfuel gas turbine system and the carbon dioxide stream is generated primarily from a second source during continued operation of the oxyfuel gas turbine system.

44. The system of claim 43 wherein the first source is an oil well and the second source is the gaseous combustion stream.

45. The system of claim 1 wherein the carbon dioxide stream is compressed between substantially 12 and 18 barg prior to being received by the combustion unit.

46. The system of claim 1 wherein the plenum is in fluid communication with a steam reformer and the steam reformer is configured to use heat from the plenum exhaust stream to reform water and methane in the control fuel stream into hydrogen and carbon monoxide.

47. The system of claim 46 wherein the steam reformer is in fluid communication with and located up stream from a heat recovery steam generator.

48. The system of claim 46 wherein the steam reformer comprises a heat exchanger and a catalyst.

49. An oxyfuel gas turbine system comprising:
a combustion unit configured to produce a gaseous combustion stream;
a turbine configured to receive the gaseous combustion stream, expand the gaseous combustion stream, and exhaust the expanded gaseous combustion stream as a turbine discharge stream wherein the turbine discharge stream has a temperature of at least 1200 degrees Fahrenheit; and
a steam reformer configured to receive the turbine discharge stream; extract heat from the turbine discharge stream; and transfer the heat into a reformer feed stream to generate a reformer product stream.

50. The system of claim 49 wherein the reformer feed stream includes at least a portion of a control fuel stream.

51. The system of claim 50 wherein the reformer feed stream includes steam.

52. The system of claim 51 wherein the reformer feed stream includes carbon dioxide.

53. The system of claims 50 wherein the combustion unit is configured to receive an oxygen stream, a carbon dioxide stream, and a combined fuel stream, wherein the combined fuel stream comprises a mixture of the control fuel stream and the reformer product stream.

54. The system of claims 53 wherein the combustion unit is configured to combust the oxygen stream, the carbon dioxide stream, and the combined fuel stream to produce the gaseous combustion stream.

55. The system of claims 50 wherein a portion of the reformer product stream is further shifted and separated to generate a hydrogen-rich stream and a carbon oxide-rich stream.

56. The system of claim 55 wherein the combustion unit is configured to receive an oxygen stream, a carbon dioxide stream, and a combined fuel stream, wherein the combined fuel stream comprises a mixture of the control fuel stream and the carbon oxide-rich stream.

57. The system of claim 56 wherein the combined fuel stream further includes a portion of the H2-rich stream.

58. The system of claim 55 wherein the hydrogen-rich stream is suitable for sale as a product or to be piped to a different process.

59. The system of claims 49 wherein the reformer is coupled to a heat recovery steam generator for further cooling the turbine discharge stream.

60. The system of claims 49 further comprising a plenum located upstream of the reformer, wherein the plenum is configured to provide a residence time during which an individual component of the turbine discharge stream reacts chemically toward equilibrium and substantially converts an intermediate product to an equilibrium product.

61. The system of claim 60 further comprising a heat recovery steam generator down stream from the reformer.

62. The system of claims 49 further comprising a plenum coupled downstream of the reformer, wherein the plenum is configured to provide a residence time during which an individual component of the turbine discharge stream reacts chemically toward equilibrium and substantially converts an intermediate product to an equilibrium product.

63. The system of claim 62 further comprising a heat recovery steam generator down stream from the plenum.

64. The system of claim 49 wherein a distance between the reformer and a discharge nozzle of the turbine is less than 5 meters.

65. The system of claim 49 wherein the residence time between the reformer and a discharge nozzle of the turbine is less than 0.1 s.

66. The system of claim 49 wherein the gaseous combustion stream has a temperature substantially between 1900 and 2700 degrees Fahrenheit.

67. The system of claim 49 wherein the steam reformer is in fluid communication with and located up stream from a heat recovery steam generator.

68. The system of claim 49 wherein the steam reformer is directly coupled to the turbine.

69. The system of claim 49 wherein the steam reformer comprises a heat exchanger and a catalyst.

70. An method for use with an oxyfuel gas turbine system, the method comprising:
providing an oxygen stream, a carbon dioxide stream, and a control fuel stream;
combusting the oxygen stream, the carbon dioxide stream, and the control fuel stream to produce a gaseous combustion stream;
expanding the gaseous combustion stream across a turbine to form an expanded gaseous combustion stream; and
providing a residence time for the expanded gaseous combustion stream to reach substantial chemical equilibrium, wherein the residence time is provided by a plenum configured to retain the expanded gaseous combustion stream for the residence time.

71. The method of claim 70 further comprising the step of generating power from the step of expanding the gaseous combustion stream across a turbine.

72. The method of claim 70 further comprising the steps of:
extracting carbon dioxide from the gaseous combustion stream; and
applying the carbon dioxide in an Enhanced Oil Recovery process.

73. The method of claim 70 wherein the residence time is substantially between 0.1 and 10 seconds.

74. The method of claim 70 wherein the residence time is substantially between 0.1 and 2 seconds.

75. The method of claim 70 wherein the residence time is greater than or equal to 1 second.

76. The method of claim 70 wherein the plenum has a center line length substantially between 10 and 30 meters.

77. The method of claim 70 wherein the plenum has a center line length greater than or equal to 30 meters.

78. The method of claim 70 wherein the combusting step produces a gaseous combustion stream having a temperature substantially between 1900 and 2700 degrees Fahrenheit.

79. The method of claim 70 wherein the combusting step produces a gaseous combustion stream having a temperature substantially between 2200 and 2500 degrees Fahrenheit.

80. The method of claim 70 wherein the combusting step produces a gaseous combustion stream having a composition substantially between 70 and 80 percent carbon dioxide.

81. The method of claim 70 further comprising the step of compressing the carbon dioxide stream prior to the combusting step.

82. The method of claim 70 further comprising the step of generating power, using a Heat recovery steam generator, from the expanded gaseous combustion stream after the step of providing a residence time.

83. The method of claim 70 further comprising the step of reforming methane using heat extracted from the expanded gaseous combustion stream after the step of providing a residence time, wherein the methane is reformed into hydrogen and carbon monoxide.

84. An method for use with an oxyfuel gas turbine system, the method comprising:
providing an oxygen stream, a carbon dioxide stream, a control fuel stream, and a reformed control fuel stream;
combusting the oxygen stream, the carbon dioxide stream, and the reformed control fuel stream to produce a gaseous combustion stream having a temperature of at least 1800 degrees Fahrenheit;
expanding the gaseous combustion stream across a turbine to form an expanded gaseous combustion stream; and
reforming the control fuel stream to form the reformed control fuel stream using heat extracted from the expanded gaseous combustion stream, wherein the reformed control fuel stream is characterized by an increase in hydrogen as compared to the control fuel stream.

85. The method of claim 84 further comprising the step of generating power from the step of expanding the gaseous combustion stream across a turbine.

86. The method of claim 84 wherein the combusting step produces a gaseous combustion stream having a temperature substantially between 1900 and 2700 degrees Fahrenheit.

87. The method of claim 84 wherein the combusting step produces a gaseous combustion stream having a temperature substantially between 2200 and 2500 degrees Fahrenheit.

88. The system of claim 49 wherein the reformer is selected from the group consisting of a steam reformer and an auto thermal reformer.
